(19) United States
(12) Patent Application Publication
(10) Pub. No.: US 2017/0329642 A1
(43) Pub. Date: Nov. 16, 2017

(54) MANY-CORE SYSTEM AND OPERATING METHOD THEREOF

(71) Applicant: ELECTRONICS AND TELECOMMUNICATIONS RESEARCH INSTITUTE, Daejeon (KR)

(72) Inventors: Jin Mee KIM, Daejeon (KR); Kwang Won KOH, Daejeon (KR); Kang Ho KIM, Daejeon (KR); Jeong Hwan LEE, Hwaseong (KR); Seung Hyub JEON, Anyang (KR); Sung In JUNG, Daejeon (KR); Yeon Jeong JEONG, Daejeon (KR); Seung Jun CHA, Daejeon (KR)

(21) Appl. No.: 15/234,785

(22) Filed: Aug. 11, 2016

(30) Foreign Application Priority Data
May 13, 2016 (KR) 10-2016-0058658

(51) Int. Cl. G06F 9/50; G06F 11/07

(52) U.S. Cl. CPC G06F 9/5027; G06F 11/0721; G06F 11/079

(57) ABSTRACT

Provided is a many-core system including a resource unit including a resource needed for execution of an operating system and a resource needed for execution of a lightweight kernel, a programing constructing unit configured to convert an input program into an application program and to load the application program into the resource unit, a run-time management unit configured to manage a running environment for executing the application program, and a self-organization management unit configured to monitor the application program and the resources in the resource unit, to dynamically adjust the running environment to prevent a risk factor from occurring during the execution of the application program, and to cure a risk factor which occurred.

### CROSS-REFERENCE TO RELATED APPLICATION

This application claims priority to and the benefit of Korean Patent Application No. 10-2016-0058658, filed on May 13, 2016, the disclosure of which is incorporated herein by reference in its entirety.

### BACKGROUND

### 1. Field of the Invention

The present invention relates to a many-core system, and more particularly, to a many-core system configured to perform an operating system service and an application execution in different cores, and an operating method thereof.

### 2. Discussion of Related Art

A many-core system currently includes several tens of cores in a single system, but has a development trend toward including several hundreds of cores. In contrast, since an operating system still only supports a single core or several tens of cores to several thousands of cores, there is a limitation in scalability for the number of cores.

Meanwhile, there are some cases in which an operating system cannot adequately manage hardware resources and an operating system service and an application use the same core. Accordingly, the application may fail to ensure appropriate hardware resources, so that a system, that is, even a many-core system, may fail to sufficiently utilize the performance of hardware.

In addition, under the current many-core system, even a calculation-dedicated application which needs to utilize multiple cores in a parallel manner may use the same core as the core which is executing the operating system service so that the performance of the application may be interrupted by the operating system and it may be difficult to secure the performance of the application.

### SUMMARY OF THE INVENTION

The present invention is directed to providing a many-core system configured to perform an operating system service and an application execution in different cores and an operating method thereof.

The technical objectives of the inventive concept are not limited to the above disclosure; other objectives may become apparent to those of ordinary skill in the art based on the following descriptions.

To achieve the above-described objectives, a many-core system according to the present invention includes: a resource unit including a resource needed for execution of an operating system and a resource needed for execution of a lightweight kernel; a programing constructing unit configured to convert an input program into an application program and to load the application program into the resource unit; a run-time management unit configured to manage a running environment for executing the application program; and a self-organization management unit configured to monitor the application program and the resources in the resource unit, to dynamically adjust the running environment to prevent a risk factor from occurring during execution of the application program, and to cure a risk factor which has occurred.

The resource unit may include an operating processor including the resource needed for the execution of the operating system, and an application processor including the resource needed for the execution of the lightweight kernel.

The operating processor may include multiple operation execution cores that actually execute a function of the operating system, and a first memory shared by the multiple operation execution cores.

The application processor may include multiple application execution cores that actually execute a function of the lightweight kernel, and a second memory shared by the multiple a application execution cores.

The programming construction unit may include a program converting unit configured to create the application program by converting a program to be executable in the running environment, and an application loader configured to load the application program into the resource unit.

The program converting unit may convert the program into the application program in the operating system, and the application loader may load the application program into the resource unit in the operating system.

The application loader may load the application program created by the program converting unit into a memory shared by multiple application execution cores that execute the application program.

The run-time management unit may receive a state of the resources in the resource unit through the lightweight kernel, and manage the running environment of the application program.

The self-organization management unit may include: a workload adjustment unit configured to monitor and adjust a workload based on a running state of the application program; an automatic environment adjustment unit configured to automatically adjust an operating environment based on a state of the application program and a state of the resources to prevent an occurrence of the risk factor and cure the risk factor; and a monitoring unit configured to monitor the state of the application program and the state of the resources in real time through the lightweight kernel and the runtime management unit.

The automatic environment adjustment unit may include; a construction adjustment unit configured to extract resource utilization function information to utilize a resource needed for the execution of the application program; an optimal adjustment unit configured to adjust a current operating environment to be optimized for the application program; a protection adjustment unit configured to adjust the operating environment to correspond to the workload according to the execution of the application program; and a cure adjustment unit configured to adjust the operating environment to cure the risk factor which has occurred.

A method of operating a many-core system according to the present invention includes: executing an application that is registered; changing a state of the application when it is determined that there is a need to change the state of the application as a result of monitoring a workload of the application after the executing of the application; and changing a state of the system when it is determined that there is a need to change the state of the system as a result of monitoring the system after the executing of the application.

In the changing of the state of the application, the state of the application may be identified when it is determined that there is a need to change the state of the application, and the state of the application may be changed on the basis of the identified state of the application.

The executing of the registered application may include registering an execution of the application and registering the state of the application.

The changing of the state of the application may include newly registering the changed state of the application, and in the executing of the registered application, the application may be executed on the basis of the newly registered state of the application.

In the changing of the state of the application, the state of the application may be changed by reflecting the state of the system according to the changing of the state or the system thereon.

In the changing of the state of the system, the state of the system may be identified when it is determined that there is a need to change the state of the system, and the state of the system may be changed on the basis of on the identified state of the system

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating an example of a configuration of a many-core system according to an exemplary embodiment of the present invention;

FIG. 2 is a diagram illustrating an example of a configuration of a self-organization management unit in a many-core system according to an exemplary embodiment of the present invention;

FIG. 3 is a diagram illustrating a relationship between components of a self-organization management in a many-core system according to exemplary embodiment of the present invention;

FIG. 4 is a flowchart showing a sequence of loading an application program in a many-core system according to an exemplary embodiment of the present invention; and

FIG. 5 is a flowchart showing a sequence of executing an application in a many-core system according to an exemplary embodiment of the present invention.

### DETAILED DESCRIPTION OF EXEMPLARY EMBODIMENTS

The above objects and other advantages, and a scheme for the advantages of the present invention should become readily apparent by reference to the following detailed description when considered in conjunction with the accompanying drawings. However, the scope of the present invention is not limited to such embodiments and the present invention may be realized in various forms. The embodiments to be described below are merely exemplary embodiments provided to fully disclose the present invention and assist those skilled in the art to completely understand the present invention, and the present invention is defined only by the scope of the appended claims. In assigning reference numerals to elements, the same reference numerals are used to designate the same elements throughout the drawings.

In describing the present invention, detailed descriptions that are well-known but are likely to obscure the subject matter of the present invention will be omitted in order to avoid redundancy. The terminology used herein is defined in consideration of its function in the present invention, and may vary with an intention of a user and an operator or custom. Accordingly, the definition of the terms should be determined on the basis of overall content of the specification.

The present invention provides a method for allowing a computing resource of a many-core system to be independently allocated to a certain application, thereby maximally utilizing the computing performance.

In addition, the present invention allows an application and an operating system to be performed in separated cores in a many-core system environment such that a core performing an application utilizes a lightweight kernel supporting minimum functions controlling execution and hardware, thus the performance of the application is not interrupted by the operating system.

In addition, the present invention not only allows the application and the operating system to be executed in different cores, but also dynamically allocates system resources according to an environmental change based on a workload of the application during execution of the application, and detects and handles risk factors and errors of a system, thereby ensuring the performance and the stability of the application on many-cores.

Hereinafter, a many-core system according to an exemplary embodiment of the present invention and an operating method thereof will be described with reference to the accompanying drawings in detail.

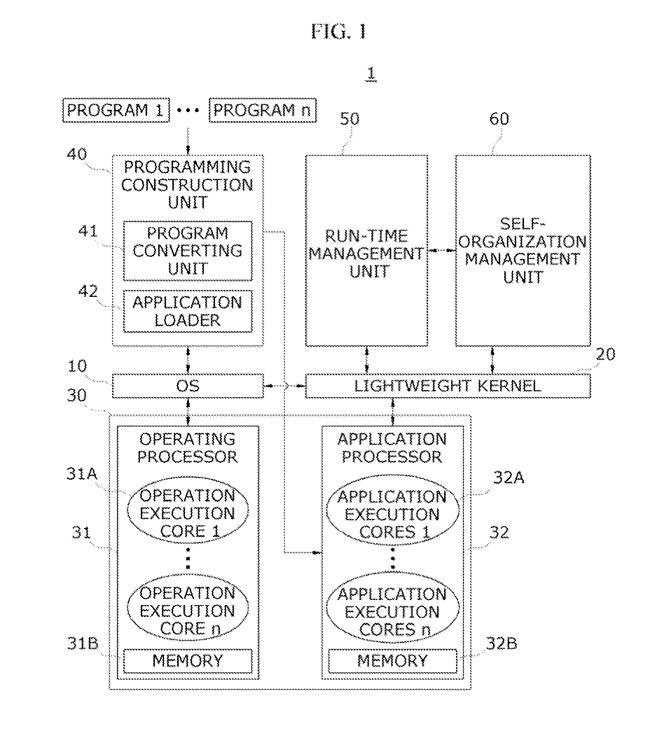

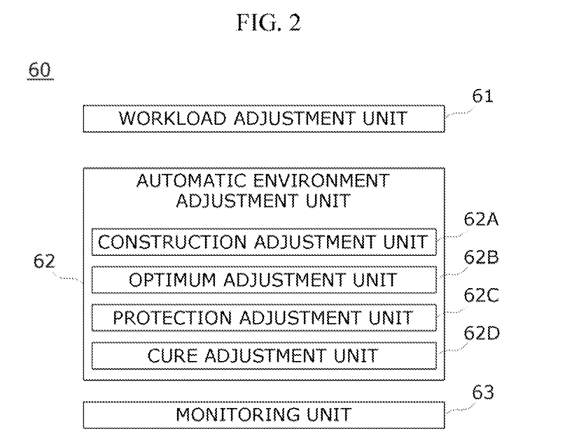

FIG. 1 is a diagram illustrating an example of a configuration of a many-core system according to an exemplary embodiment of the present invention, and FIG. 2 is a diagram illustrating an example of a configuration of a self-organization management unit in a many-core system according to an exemplary embodiment of the present invention.

Referring to FIG. 1, a many-core system 1 according to an exemplary embodiment of the present invention includes a resource unit 30, a programming construction unit 40, a run-time management unit 50, and a self-organization management unit 60.

The resource unit 30 includes a resource needed for execution of an operating system 10 and a resource needed for execution of a lightweight kernel 20.

According to the present invention, the operating system 10 and the lightweight kernel 20 perform different functions, the operating system 10 runs and operates the system 1, and the lightweight kernel 20 executes an application.

Accordingly, the resource unit 30 includes an operating processor 31 including the resource needed for execution of the operating system 10 and an application processor 32 including the resource needed for execution of the lightweight kernel 20.

In this case, the operating processor 31 includes multiple cores (‘operation execution cores 31a’) which actually execute a function of the operating system 10 and a first memory 32b shared by the multiple operation execution cores 31a.

In addition, the application processor 32 includes multiple cores (‘application execution cores 32a’) which actually execute a function of the lightweight kernel 20 and a second memory 32b shared by the multiple application execution cores 32a. In this case, the application execution cores 32a execute an application program.

The programming construction unit 40 converts an input program into an application program in the operating system, and loads the application program into the resource unit 30, in particular, the second memory 32b of the application processor 32.

In this case, the programming construction unit 40 may include a program converting unit 41 and an application loader 42.

The program converting unit 41 creates an application program by converting an input program to be executable in a running environment. At this time, the application program created by the program converting unit 41 is loaded into the application loader 42.

The application loader 42 loads the application program created by the program converting unit 41 into the second memory 32b of the application processor 32 through the operating system.

According to the present invention, the application program is created in the operating system, and is loaded into the second memory 32b of the application processor 32 through the operating system.

The run-time management unit 50 is configured to manage a running environment for executing the application program in real time, and manages the running environment such that an application program being executed is executed an optimized environment.

In this case, the run-time management unit 50 receives states of the application execution cores 32a and the second memory 32b in the application processor 32 via communication with the lightweight kernel 20, and manages the running environment of the application program based on the received states of the application execution cores 32a and the second memory 32b.

For example, the run-time management unit 50 manages the number of the application execution cores 32a and an allocation area of the second memory 32b such that the application program is executed in the optimized environment.

The self-organization management unit 60 monitors the application program and the resources in the resource unit 30 in real time via communication with the lightweight kernel 20 and the run-time management unit 50.

In addition, the self-organization management unit 60 dynamically adjusts resources to prevent an occurrence of a risk factor (such as an overload and errors) that may occur during execution of the application program and to cure a risk factor when it occurs.

In addition, the self-organization management unit 60 manages the resources to be optimally disposed during operation of the application according to a workload use pattern of the application and a system resource environment.

Referring to FIG. 2, the self-organization management unit 60 includes a workload adjustment unit 61, an automatic environment adjustment unit 62, and a monitoring unit 63.

The workload adjustment unit 61 may be configured to monitor and adjust a workload based on an execution state of the application.

In this case, the workload adjustment unit 61 collects basic information by performing automatic profiling on the workload so that the basic information is utilized by other adjustment units, and adjusts the workload to satisfy a target based on availability, a response time, and a throughput.

The automatic environment adjustment unit 62 automatically adjusts an operating environment based on a state of the application and a state of the resources to prevent an occurrence of a risk factor and cure the risk factor.

Meanwhile, the automatic environment adjustment unit 62 includes a construction adjustment unit 62a, an optimal adjustment unit 62b, a protection adjustment unit 62c, and a cure adjustment unit 62d.

The construction adjustment unit 62a extracts resource utilization function information to utilize the resource needed for execution of the application to automatically construct a system operating environment optimized for the application.

In this case, the workload adjustment unit 62a recognizes schedules of the other adjustment units 62b, 62c and 62d and performs the execution.

The optimal adjustment unit 62b adjusts the current operating environment such that the system resources are optimized in the current load condition during execution of the application. For example, the optimal adjustment unit 62b may increase or decrease a memory usage according to the workload.

The protection adjustment unit 62c adjusts the operating environment by detecting a change in the system environment along with risk factors and errors of the system according to the workload of the application. For example, the protection adjustment unit 62c may set a resource to offline when intrusion is detected.

The cure adjustment unit 62d adjusts the operating environment such that a risk factor having occurred is cured. In detail, in a state in which the application is unable to use the system resources, the cure adjustment unit 62d adjusts and replaces required resources based on a policy while ensuring the execution of the application.

The monitoring unit 63 monitors the state of the application and the state of the resources through the lightweight kernel 20 and the runtime management unit 50 in real time.

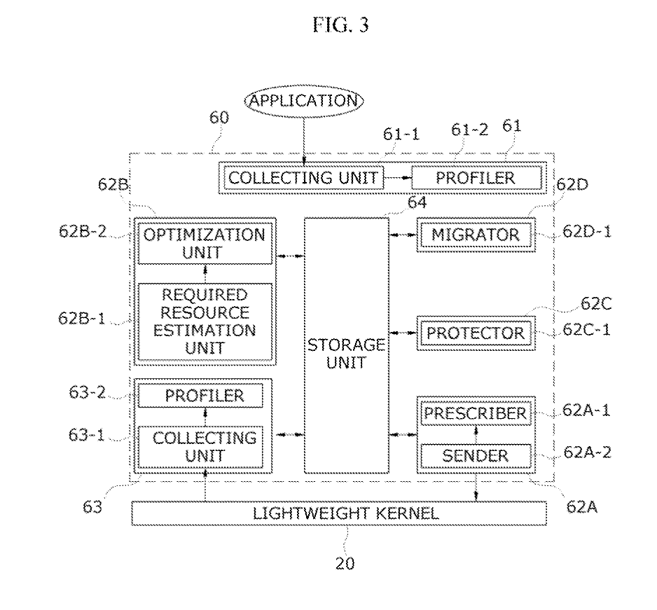

Hereinafter, a relationship between components of a self-organization management unit in a many-core system according to an exemplary embodiment of the present invention will be described in detail with reference to FIG. 3.

FIG. 3 is a diagram illustrating a relationship between components of a self-organization management unit in a many-core system according to an exemplary embodiment of the present invention.

Referring to FIG. 3, the workload adjustment unit 61 and the monitoring unit 63 periodically collect information (application information and resource information) through the lightweight kernel 20, and make profiles with respect to a resource use and a workload.

To this end, the workload adjustment unit 61 and the monitoring unit 63 include collecting units 61-1 and 63-1, respectively, which collect information and profilers 61-2 and 63-2, respectively, which make profiles.

The optimal adjustment unit 62b estimates resources needed for application execution, distinguishes resources by using an upper threshold and a lower threshold, and outputs resource requirements for the distinguished resources.

To this end, the optimal adjustment unit 62b may include a required resource estimation unit 62b-1 which estimates resources needed for application execution and an optimization unit 62b-2 which distinguishes the resources by using the upper threshold and the lower threshold and outputs the resource requirement for the distinguished resources.

The cure adjustment unit 62d distinguishes an overloaded resource, calculates resource requirements being operated in the distinguished resource, selects resources to migrate according to a policy, and determines the sequence and the amount of resources to be allocated. To this end, the cure adjustment unit 62d may include a migrator 62d-1.

The protection adjustment unit 62c detects a risk factor of the system and determines a way of removing the risk factor. To this end, the protection adjustment unit 62c may include a protector 62c-1.

In addition, the construction adjustment unit 62a creates detailed instructions for resource reallocation and migration that need to be performed in the system and detailed instructions for the protection adjustment unit 62c by using a result of execution of the optimum adjustment unit 62b, the protection adjustment unit 62c, and the cure adjustment unit 62d, and transmits the created instructions to the lightweight kernel 20. To this end, the construction adjustment unit 62a may include a prescriber 62a-1 that creates instructions and a sender 62a-2 that transmits the instructions.

In addition, the self-organization management unit 60 includes a storage unit 64 that shares information among the workload adjustment unit 61, the construction adjustment unit 62a, the optimum adjustment unit 62b, the protection adjustment unit 62c, the cure adjustment unit 62d, and the monitoring unit 63.

The construction and function of the many-core system according to an exemplary embodiment of the present invention have been described above. Hereinafter, an operation of the many-core system according to an exemplary embodiment of the present invention will be described with reference to the accompanying drawings in detail.

First, an operation of loading an application program in a many-core system according to an exemplary embodiment of the present invention will be described.

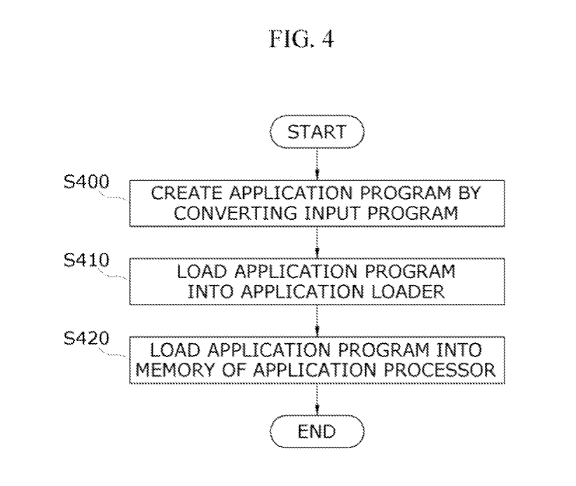

FIG. 4 is a flowchart showing a sequence of loading an application program in a many-core system according to an exemplary embodiment of the present invention.

Referring to FIG. 4, the program converting unit 41 creates an application program by converting an input program to be executable in a running environment (S400). At this time, a process of converting the program into the application program is achieved in an operating system.

The application program created in operation S400 is loaded into the application loader 42 by the program converting unit 41 (S410).

After operation S410, the application loader 42 loads the application program loaded by the program converting unit 41 into the second memory 32b of the application processor 32 through the operating system (S420).

According to the present invention, the application program is created in the operating system and is loaded into the second memory 32b of the application processor 32 through the operating system and executed by the application processor 32.

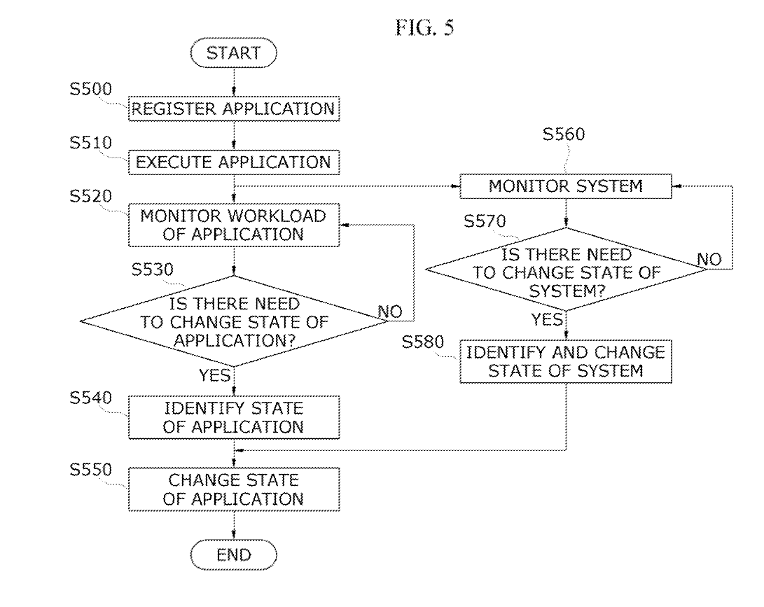

FIG. 5 is a flowchart showing a sequence of executing an application in many-core system according to an exemplary embodiment of the present invention.

Referring to FIG. 5, an application is registered (S500), and execution of the application is achieved (S510). In operation S500, the execution of the application and a state of the application are registered.

When the application is executed as such, a system monitoring and a self-operation are performed by the run-time management unit 50 and the self-organization management unit 60 cooperating.

When the application is executed according to operation S510, a workload of the application is monitored (S520), and it is determined whether there is a need to change the state of the application in order to optimize the workload (S530).

If it is determined as a result of operation S530 that there is no need to change the state of the application (NO of operation S530), feedback is made to operation S520 to monitor the workload of the application.

Meanwhile, if it is determined as a result of operation S530 that there is a need to change the state of the application (YES of operation S530), the state of the application is identified (S540) and the state of the application is changed on the basis of the identified state of the application (S550).

When the changing of the state of the application is completed according to operation S550, a feedback is made to operation S500, and the changed state of the application is registered.

In this case, operations S520 to S550 may be performed by the run-time management unit 50 of the many-core system 1.

Meanwhile, while the run-time management unit 50 is performing operations S520 to S550 according to the execution of the application in operation S510, the self-organization management unit 60 performs operations S560 to S580.

That is, when the application is executed in operation S510, the self-organization management unit 60 monitors the system (S560), and determines whether there is a need to change the state of the system (S570).

If it is determined as a result of operation S570 that there is no need to change the state of the system (NO of operation S570), a feedback is made to operation S560 to monitor the system.

Meanwhile, if it is determined as a result of operation S570 that there is a need to change the state of the system (YES of operation S570), the state of the system is identified and the state of the system is changed on the basis of the identified state of the system (S580).

Meanwhile, in the case in which the state of the application is changed according to operation S550, the run-time management unit 50 changes the state of the application by reflecting the system state changed according to operation S580, thereon.

As is apparent from the above, an operating system service and an application can be performed in different cores, thereby ensuring the performance of the application.

In addition, system resources can be dynamically allocated according to an environment change based on a workload of an application during execution or the application and risk factors and errors of the system can be detected and dealt with, thereby ensuring the performance and the stability of the system.

Although the many-core system according to the present invention and the operation method thereof have been described above, it should be understood that there is no intent to limit the present invention to the particular forms disclosed, and on the contrary, the disclosure is to cover all modifications, equivalents, and alternatives falling within the spirit and scope of the disclosure.

Therefore, the exemplary embodiments disclosed in the present invention and the accompanying drawings are intended not to limit but to illustrate the technical spirit of the present invention, and the scope of the present invention is not limited by the exemplary embodiments and the accompanying drawings. The protective scope of the present invention should be construed on the basis of the accompanying claims, and all of the technical ideas included within the scope equivalent to the claims belong should be construed as belonging thereto.

What is claimed is:

1. A many-core system comprising:
a resource unit including a resource needed for execution of an operating system and a resource needed for execution of a lightweight kernel;
a programing constructing unit configured to convert an input program into an application program and to load the application program into the resource unit;
a run-time management unit configured to manage a running environment for executing the application program; and
a self-organization management unit configured to monitor the application program and the resources in the resource unit, to dynamically adjust the running environment to prevent a risk factor from occurring during execution of the application program, and to cure a risk factor which has occurred.

2. The many-core system of claim 1, wherein the resource unit includes:
an operating processor including the resource needed for the execution of the operating system; and
an application processor including the resource needed for the execution of the lightweight kernel.

3. The many-core system of claim 2, wherein the operating processor includes: multiple operation execution cores that actually execute a function of the operating system; and
a first memory shared by the multiple operation execution cores.

4. The many-core system of claim 2, wherein the application processor includes multiple application execution cores that actually execute a function of the lightweight kernel; and
a second memory shared by the multiple application execution cores.

5. The many-core system of claim 1, wherein the programming construction unit includes:
a program converting unit configured to create the application program by converting a program to be executable in the running environment; and
an application loader configured to load the application program into the resource unit.

6. The many-core system of claim 5, wherein the program converting unit converts the program into the application program in the operating system, and the application loader loads the application program into the resource unit in the operating system.

7. The many-core system of claim 5, wherein the application loader loads the application program created by the program converting unit into a memory shared by multiple application execution cores that execute the application program.

8. The many-core system of claim 1, wherein the run-time management unit receives a state of the resources in the resource unit through the lightweight kernel, and manages the running environment of the application program.

9. The many-core system of claim 1, wherein the self-organization management unit includes:
a workload adjustment unit configured to monitor and adjust a workload based on a running state of the application program;
an automatic environment adjustment unit configured to automatically adjust an operating environment based on a state of the application program and a state of the resources to prevent an occurrence of the risk factor and cure the risk factor; and
a monitoring unit configured to monitor the state of the application program and the state of the resources in real time through the lightweight kernel and the runtime management unit.

10. The many-core system of claim 9, wherein the automatic environment adjustment unit comprises:
a construction adjustment unit configured to extract resource utilization function information to utilize a resource needed for the execution of the application program;
an optimal adjustment unit configured to adjust a current operating environment to be optimized for the application program;
a protection adjustment unit configured to adjust the operating environment to correspond to the workload according to the execution of the application program; and
a cure adjustment unit configured to adjust the operating environment to cure the risk factor which has occurred.

11. A method of operating a many-core system, the method comprising:
executing an application that is registered;
changing a state of the application when it is determined that there is a need to change the state of the application as a result of monitoring a workload of the application after the executing of the application; and
changing a state of the system when it is determined that there is a need to change the state of the system as a result of monitoring the system after the executing of the application.

12. The method of claim 11, wherein in the changing of the state of the application, the state of the application is identified when it is determined that there is a need to change the state of the application, and the state of the application is changed on the basis of the identified state of the application.

13. The method of claim 11, wherein the executing of the registered application includes registering an execution of the application and registering the state of the application.

14. The method of claim 13, wherein the changing of the state of the application includes newly registering the changed state of the application, and in the executing of the registered application, the application is executed on the basis of the newly registered state of the application.

15. The method of claim 11, wherein in the changing of the state of the application, the state of the application is changed by reflecting the state of the system according to the changing of the state of the system thereon.

16. The method of claim 11, wherein in the changing of the state of the system, the state of the system is identified when it is determined that there is a need to change the state of the system, and the state of the system is changed on the basis of the identified state of the system.
